(19) United States
(12) Patent Application Publication
(10) Pub. No.: US 2013/0105239 A1
(43) Pub. Date: May 2, 2013

(54) Telerobot for Facilitating Interaction between Users

(71) Applicant: Hei Tao Fung, Fremont, CA (US)

(72) Inventor: Hei Tao Fung, Fremont, CA (US)

(21) Appl. No.: 13/656,736

(22) Filed: Oct. 21, 2012

Related U.S. Application Data
(60) Provisional application No. 61/569,222, filed on Dec. 10, 2011.
(60) Provisional application No. 61/543,808, filed on Oct. 30, 2011.

(51) Int. Cl. B62D 61/00

(52) U.S. Cl. 180/218; 901/1

(57) ABSTRACT

A telerobot is designed for facilitating interaction between a remote user who is controlling the telerobot and a local user who is co-located with the telerobot. It comprises two wheels whose axes are aligned horizontally. It is designed to have its center of gravity located between the bottom of its body and the axes of its wheels so that it can stand up when powered or unpowered and can recover automatically after being toppled by an external force. Its camera's viewing angle can be adjusted to compensate for the swaying of its body due to inertia when it moves so that the remote user has a pleasant viewing experience. It supports gesture control text input so that the local user may input data into the telerobot without touching it. A virtual keyboard displayed on its screen has a layout optimized for gesture control text input.

### FIELD OF THE INVENTION

The present invention relates to a telerobot.

### BACKGROUND

A telerobot is a robot that enables a remote user to control it and perform work remotely. Some telerobots are designed to facilitate human interaction, between remote users who control the telerobots and local users who are co-located with the telerobots. As an example, a remote receptionist controls a telerobot to take care of guests entering an office where the telerobot is physically present. The activities involved may be greeting, getting names and guests' information, and providing directions. Such kind of telerobots needs to be mobile and self-reliant, as local users are not expected to take care of the telerobots. Also, for the interaction between the remote users and the local users it needs to provide videoconferencing capability as well as text input or choice selection capability for the local users. Our invention relates to a robot of this kind, taking advantage of the recent technology advancement in computing tablet.

### SUMMARY OF THE INVENTION

The object of this invention is a telerobot that is mobile, self-reliant, and capable of supporting videoconferencing and text input.

In our preferred embodiment, the telerobot has a body comprising motors and gears to drive two wheels independently. The axes of the two wheels are aligned horizontally, like a Segway vehicle. It can move forward, backward, turn, and rotate to provide the mobility. There is a pole jutting out of the body, and a computing tablet is affixed to the higher end of the pole. A two-wheel, low-gravity design enables the telerobot to remain upright, i.e., the pole is standing up, the computing tablet being lifted up and facing a local user. The telerobot design is different from the Segway vehicle in that the Segway vehicle would fall when unpowered whereas the telerobot is meant to stand upright regardless of being powered or unpowered. That is achieved by designing the center of gravity of the robot to be positioned between the axes of the wheels and the bottom of the body. When the only contact points of the telerobot with the ground are the two wheels, the pole is lifted up by the nature of gravity like tipping over a balance. With the recent technology advancement in computing tablet, a computing tablet is an excellent choice to provide videoconferencing capability, text input, and remote control via wireless network. Nowadays, a computing table can easily weigh below one pound. The pole can be made of light-weight materials such as fiber-glass reinforced plastics. Although the computing tablet is a few times farther away from the axes of the wheels than the bottom of the body from the axes of the wheels, by putting weighty components, such as motors, gears, batteries, and even weights, near the bottom of the body, the center of gravity can be positioned between the axes of the wheels and the bottom of the body. The telerobot may by toppled by a strong enough external force onto the pole or the computing tablet, but the telerobot, designed to be self-reliant, is going to stand up again without any assistance from a local user.

A primitive two-wheel, low-gravity design has a drawback. When the telerobot is to move, the inertia causes the computing tablet to sway in the opposite direction of the movement. Such behavior causes some viewing discomfort to a remote user controlling the telerobot. Our invention addresses the problem by providing a mechanism that controls the inclination of the computing tablet relative to the body. There are two advantages. Firstly, the mechanism can help compensate for the swaying motion caused by the movement of the telerobot. Secondly, the mechanism can change the viewing angle of the computing tablet even when the telerobot is standing still, enabling the remote user to adjust the viewing angle in the vertical dimension.

A primitive two-wheel, low-gravity design has another drawback. When a local user would like to key in some text on the computing tablet, the user pushes on the touchscreen of the computing tablet and causes the telerobot to sway. Although the user could hold on to the pole while pressing on the touchscreen, it is desirable not to require the user to touch the telerobot at all. It is a way to keep the telerobot clean. Our invention addresses the problem with gesture control text input.

A further object in this disclosure is a method for gesture control text input on a virtual keyboard displayed on a computing tablet. The computing tablet tracks the movement of a fingertip and moves a cursor over the virtual keyboard to select a key as input. The virtual keyboard layout, as opposed to the QWERTY style, is optimized for minimizing fingertip movement for inputting text.

### BRIEF DESCRIPTION OF THE DRAWINGS/FIGURES

The present invention will be understood more fully from the detailed description that follows and from the accompanying drawings, which however, should not be taken to limit the disclosed subject matter to the specific embodiments shown, but are for explanation and understanding only.

FIG. 1 illustrates the outlook of an embodiment of the telerobot disclosed.

FIG. 2 illustrates the front view of an embodiment of the telerobot disclosed.

FIG. 3 illustrates the first embodiment of controlling the inclination of the computing tablet.

FIG. 4 illustrates the second embodiment of controlling the inclination of the computing tablet.

FIG. 5 illustrates the third embodiment of controlling the inclination of the computing tablet.

FIG. 6 illustrates the fourth embodiment of controlling the inclination of the computing tablet.

FIG. 7a illustrates an embodiment of shifting center of gravity.

FIG. 7b illustrates the side view of the embodiment in FIG. 7a.

FIG. 7c illustrates the opposite side view of FIG. 7b.

FIG. 8 illustrates an embodiment of virtual keyboard on the telerobot disclosed.

FIG. 9a illustrates an embodiment of the first view of the virtual keyboard.

FIG. 9b illustrates an embodiment of the second view of the virtual keyboard.

### DETAILED DESCRIPTION OF THE INVENTION

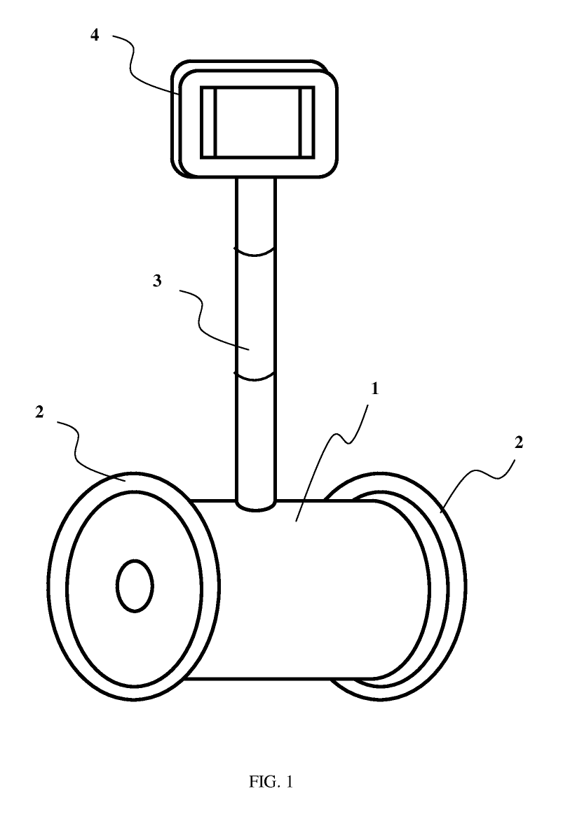

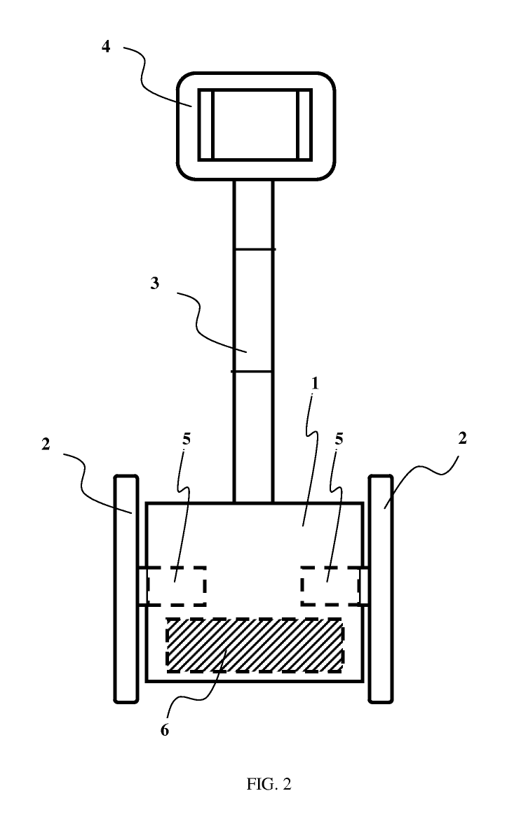

The preferred embodiment of the telerobot disclosed is illustrated in FIG. 1. The telerobot comprises a body 1, two wheels 2, a pole 3, and a computing tablet 4. The body 1 comprises a number of motors and gears, at least one battery, and some electronics and mechanical parts. The wheels 2 are attached to the body 1 and are driven independently by motors and gears inside the body 1 so that the wheels 2 can move forward and backward independently from each other. The axes of wheels 5 are aligned on an imaginary horizontal line through the body 1, as in FIG. 2. The pole 3 is jutting out of the body 1. The purpose of the pole 3 is for upholding the computing tablet 4 that is affixed to the higher end of the pole 3 to a comfortable height for a remote user, who controls the telerobot, and a local user to carry out a videoconference. The computing tablet comprises at least one camera, at least one speaker, at least one microphone, a screen, CPU and memory units, and a networking unit. In our preferred embodiment, the computing tablet is acting as a videoconference device. Other embodiments of the videoconference device are possible.

The weighty components 6 inside the body 1, such as motors, gears, and battery, are placed near the bottom of the body 1, as in FIG. 2. The weight of the weighty components is such that the center of gravity of the telerobot is located between the bottom of the body 1 and the axes of wheels 5. The shape of the body 1 is such that not any part of the body 1 touches the ground when the telerobot is standing up or when the telerobot has fallen down. The contact points of the wheels 2 to the ground are like pivots, and the pole 3 and the body 1 form a balance. By the way that the center of gravity is placed, the telerobot stands up in stable condition. When the telerobot has fallen down due to an external force, the telerobot is going to stand up again.

As an example, a typical computing tablet 4 weighs less than 1 lb. The pole 3 is made of fiber-glass-reinforced plastics. The combined weight of the computing tablet 4 and the pole 3 may be 2 lb. The diameter of the wheels 2 is 18 in. The distance of the bottom of the body 1 from the axes of wheels 5 is 8 in. The distance of the computing tablet 4 to the axes of wheels 5 is 40 in. We can then make the weight of the weighty components 6 to be far more than (40 in/8 in)(2 lb) or 10 lb. That should place the center of gravity between the axes of wheels 5 and the bottom of the body 1.

In our preferred embodiment, the pole 3 comprises multiple segments for compact storage. The pole 3 can be disassembled and the disassembled segments do not take as much space as a pole in one piece. In another embodiment, the segments of the pole 3 can be slided into and out from their adjacent segments as in telescoping.

In our preferred embodiment, the pole 3 is also hollow such that a number of cables may run through from the body 1 to the end of the pole 3 where the computing tablet 4 is affixed. Those cables may be electric cables to conduct electricity from the battery or power system inside the body 1 to any component up the pole 3 such as the computing tablet 4 or to conduct control signals from electronic components inside the body 1 to any component up the pole 3. Those cables may also be used for mechanical control.

It is desirable to be able to adjust the viewing angle of the camera on the computing tablet 4. Firstly, that facilitates the remote user maneuvering the telerobot, providing a variety of viewing angles in the vertical dimension. Secondly, when the telerobot is moving forward the pole 3 tends to sway backward due to inertia. The viewing angle of the camera can be adjusted to compensate for the swaying motion so as to provide a better viewing experience to the remote user. There can be a number of embodiments that support the adjustment of viewing angle.

In one embodiment, the inclination of the camera built into the computing tablet 4 can be adjusted by an electromechanical means built into the computing tablet 4. However, in videoconference application, it is desirable that the viewing angle of the screen of the computing tablet may be adjusted together with the viewing angle of the camera. The embodiment does not offer that capability.

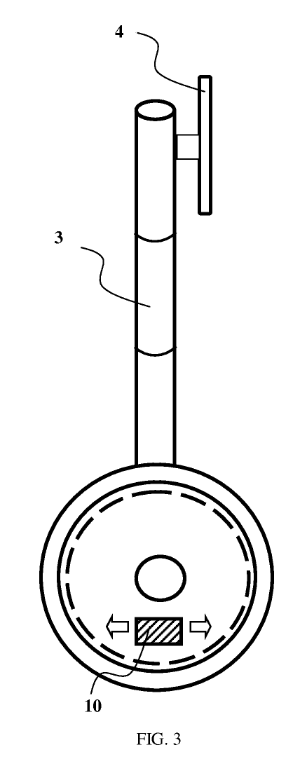

In another embodiment, as in FIG. 3, some weighty components 10 inside the body 1 can be moved frontward and backward by at least one motor which is independent of the motors driving the wheels 2 such that the center of gravity can be shifted frontward and backward. When the center of gravity is shifted backward inside the body 1, the telerobot will restores its balance, and after the telerobot is stabilized the pole 3 along with the computing tablet 4 will incline downward. When the wheels 2 are moving the telerobot forward, the telerobot tends to lean backward, and if the center of gravity is shifted backward and forward inside the body 1 at the right moments, the computing tablet may seem stable in viewing angle throughout the motion.

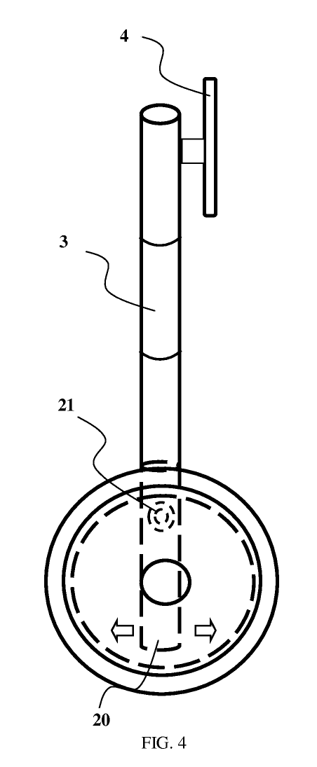

In another embodiment, as in FIG. 4, the pole 3 pivots about a hinge 21 on the upper part of the body 1 while the lower end of pole 20 can be moved frontward and backward by at least one motor which is independent of the motors driving the wheels 2.

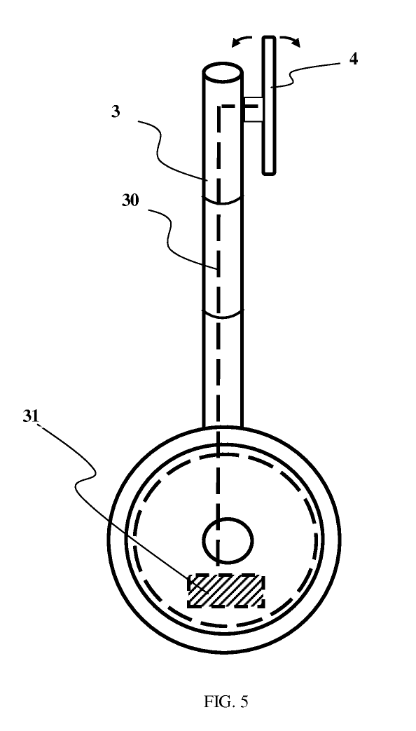

In another embodiment, as in FIG. 5, there is a cable 30 running through the pole 3, which is hollow. One end of the cable 30 is tied to a spring lever, whereas the other end of the cable 30 is tied to a wheel driven by a motor which is independent of the motors driving the wheels 2. The motor controls the pulling and releasing of the cable and therefore the ups and downs of the spring lever. The computing tablet 4 is affixed to one end of the spring lever. Therefore, the motor controls the inclination of the computing tablet 4 relative to the body 1.

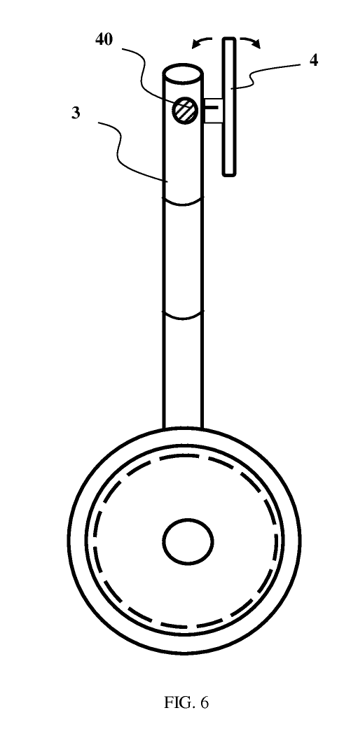

In another embodiment, as in FIG. 6, there is a motor embedded inside the upper end of the pole 3. The motor drives a worm gear. The worm gear in turn drives a wheel. The computing table 4 is affixed to the wheel. Therefore, the motor controls the inclination of the computing table 4 relative to the body 1.

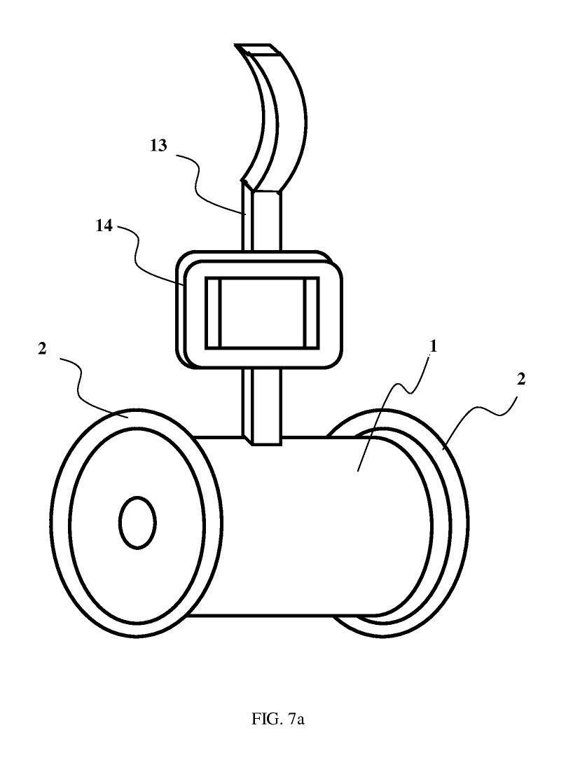

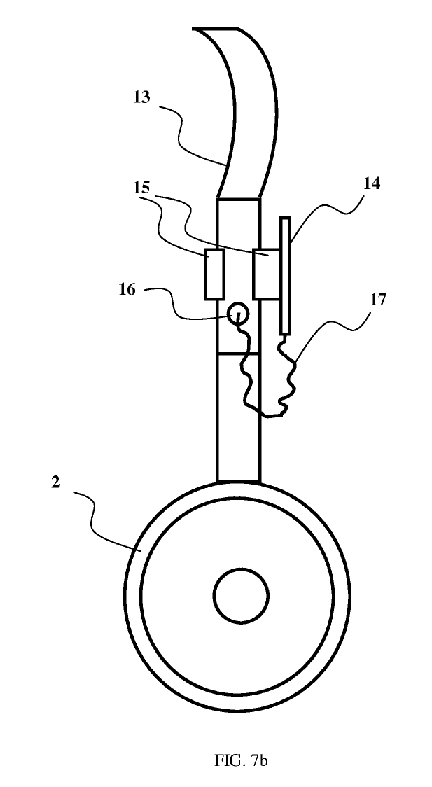

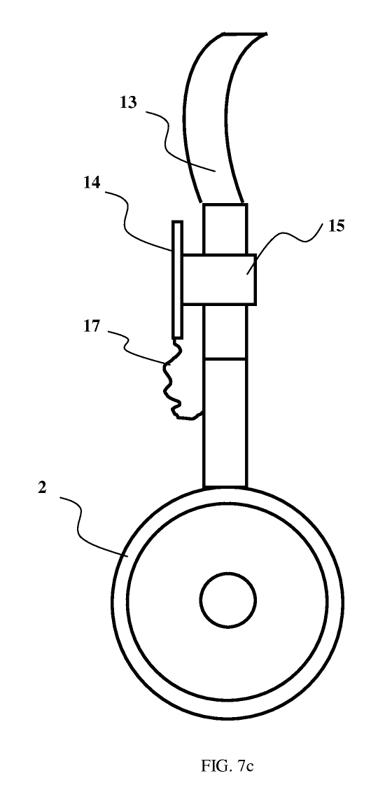

Yet in another embodiment, illustrated in FIGS. 7a, 7b, and 7c, the telerobot is meant to be flexible in supporting a variety of functions that require special equipments. For example, performing visitor reception may require a label printer; doing presentations may require a laser pointer; performing inventory tracking may require a RFID reader. Those equipments are supported through peripherals attached to the telerobot videoconference device or computing tablet. In that case, the total weight of the videoconference device and peripherals may be significant such that the center of gravity of the telerobot is located higher than the axes of the wheels, making the telerobot unstable without dynamic balancing.

The telerobot can dynamically balance itself on two wheels using well-known techniques involving taking measurements of gyroscope and accelerometer, applying filter on those measurements, and keeping the center of gravity of the telerobot on the axis of the two wheels accordingly. The telerobot does not fall down as long as the telerobot is powered and dynamically balances itself. However, when the telerobot somehow loses its balance, we need a mechanism to enable it to recover to its upright position without user's intervention.

The embodiment illustrated in FIGS. 7a-7c provides one solution. The computing tablet and peripherals 14 should be limited in weight and mainly comprise electronics and small electro-mechanical devices. The design aims at making the weight of the pole 13 and the holder 15 of the computing tablet and peripherals 14 a few times smaller than the weight of the base body 1. A holder 15 of the computing tablet and peripherals 14 comprises wheels and motors and can slide up and down the pole 13. The motors are controlled via the connection cables 17. The motors are used along with worm gears. The use of worm gears enables the holder 15 of the computing tablet and peripherals 14 to stay put without putting stress on the motors. When the holder 15 of the computing tablet and peripherals 14 slides to a low position down the pole 13 close to the axis of the wheels, that procedure shifts the center of gravity of the whole telerobot to be between the axis of the wheels and the bottom of the base body 1. By the physics of balance, the telerobot thus is able to stand upright even when the telerobot has fallen down. At the fall-down position, the telerobot may need to move its wheels 2 a bit to overcome some friction between the wheels 2 and the floor and trigger the balance to tip.

The main purpose of the pole 13 is for presenting the computing tablet and peripherals 14 at a height comfortable to users. The pole 13 is designed to facilitate the holder 15 of computing tablet and peripherals 14 sliding up and down. It can allow the holder 15 to go up from the body 1 to a few (four to six) feet high. It may be straight or curved, for example, like a question mark. A curved pole 13 enables the holder 15 to present the computing tablet and peripherals 14 to the users at different angles. The pole 13 is supposed to be light and strong. It may be hollow so that it can be light. Its hollowness also enables the connection cables 17 to run through inside to keep them tidy. We may have an opening 16 near the midpoint of the pole 13 to let the connection cables 17 to come out to the holder 15 of the computing tablet and peripherals 14.

To keep the connection cables 17 tidy considering that the holder 15 of computing tablet and peripherals 14 can slide up and down the pole 13, a coil cable may be used to contain the connection cables 17. The coil cable, bundling the connection cables 17 inside, runs through the pole 13 from within the base body 1, comes out near the midpoint of the pole 13 through an opening 16 and goes to the holder 15 of the computing tablet and peripherals 14.

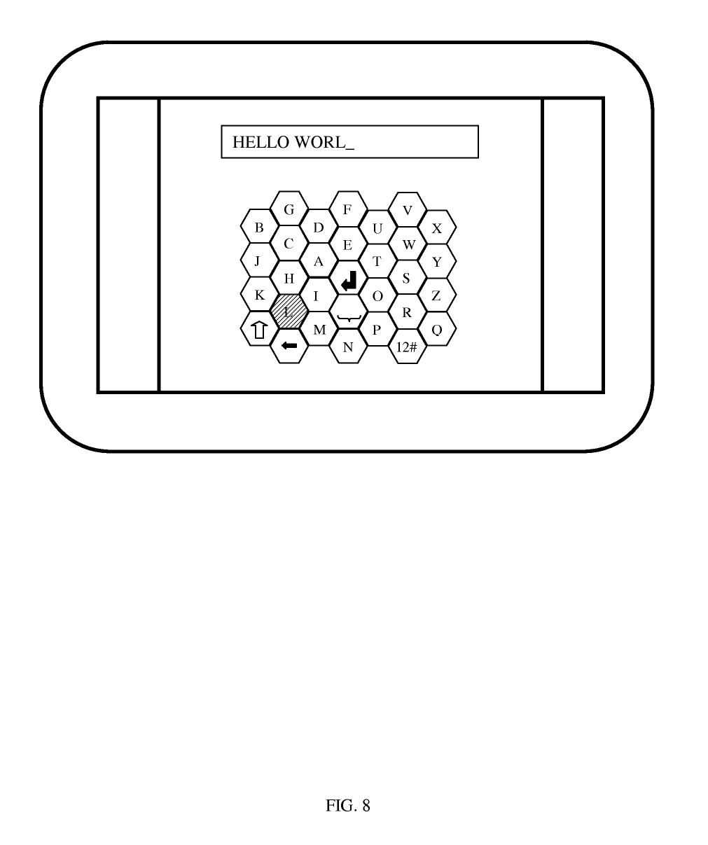

During the interaction between a remote user controlling the telerobot and a local user, the local user may be prompted to input some text, such as the name of the user, via the telerobot. It is desirable that the local user is able to do that without touching the telerobot. Firstly, touching the telerobot may cause it to sway or topple. Secondly, the telerobot may be kept clean due to less need for physical contact with users. Thirdly, the cost of the telerobot may be reduced, without the need for a keyboard or a high-performance touchscreen. To that end, gesture control text input is used in the preferred embodiment. A sequence of images is capture via the camera of the computing tablet 4. Digital image processing techniques are applied to recognize and track a fingertip of the local user. A virtual keyboard is displayed on the screen of the computing tablet 4 as in FIG. 8. When the fingertip is first detected, a cursor appears on the virtual keyboard, pointing to the center of the virtual keyboard. The movement of the fingertip is tracked; the relative movement of the fingertip moves the cursor over the virtual keyboard accordingly. For example, the ‘L’ key is highlighted in FIG. 8 as it is the key where the cursor is on. When the movement of the fingertip ceases for a period of time, for example, three seconds, the key on which the cursor is rested is treated as the input.

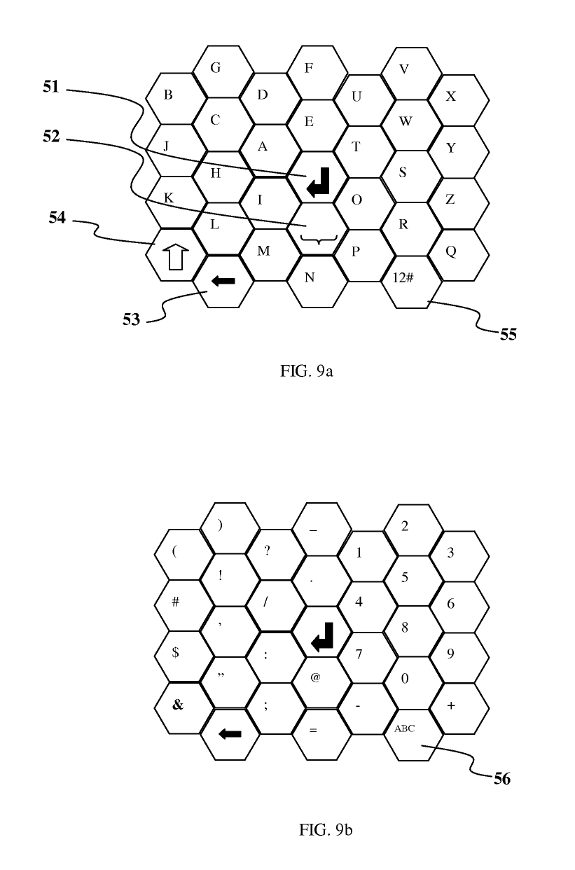

The virtual keyboard has a layout optimized for the fingertip tracking text input method. Tracking the fingertip movement to a fine precision could be challenging, and it is desirable not to require users to make big movements; therefore, there are a small number of keys on one view of the virtual keyboard, and there are an alphabet view and a number view. The layout is also designed for minimizing the fingertip movements for inputting text. The virtual keyboard comprises regular convex hexagonal keys, and the keys are joined at their edges to form a big polygon. The regular convex hexagon shape chosen allows packing more keys in a small area. The statistically most frequently used keys are placed near the center of the big polygon. The preferred embodiment is shown in FIG. 9a and FIG. 9b. For example, the most frequently used English letters are in this order: e, t, a, o, i, n, s, h, r, d, 1, c, u, m, w, f, g, y, p, b, v, k, j, x, q, and z. Also, the ‘enter’ key 51 and the ‘space’ key 52 are among the most frequently used. Furthermore, the keys of letters adjacent in alphabetical order are placed near one another so that users can locate the wanted keys easily. As in FIG. 9a, the upper left part of the virtual keyboard are keys of ‘a’ to ‘g’; the lower left part are keys of ‘h’ to ‘n’; the lower right part are keys of ‘o’ to ‘s’; the upper right part are keys of ‘t’ to ‘z’. The ‘erase’ key 53, the ‘shift’ key 54, and the ‘number view’ key 55 are there for special circumstances. The alphabet view of the virtual keyboard is optimized for inputting short English phrases such as names. The number view of the virtual keyboard is optimized for number input and for Internet related input. As in FIG. 9b, the numbers ‘0’ to ‘9’ are placed near one another, as consecutive inputs are often needed as in arithmetic calculation and in inputting telephone number. The forward slash key ‘/’, the semicolon key ‘:’, the dot key ‘.’ and the at key ‘@’ are often needed in HTTP links and email addresses. They are therefore placed near the center of the virtual keyboard. The ‘alphabet view’ key 56 is there for switching to the alphabet view.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A telerobot, comprising:
a body, comprising a plurality of motors;
two wheels, independently driven by two of said plurality of motors, with axes of wheels aligned horizontally;
a pole, jutting out of said body; and
a videoconference device, coupled to said pole;
wherein no other part of said telerobot except said two wheels contacts a floor in stable condition,
wherein center of gravity of said telerobot is between bottom of said body and said axes of wheels such that said pole is standing up in said stable condition.

2. The telerobot as in claim 1, wherein moving said videoconference device via an electro-mechanical mechanism to a low position on said pole can shift the center of gravity of said telerobot to be between said bottom of the said body and said axes of wheels.

3. The telerobot as in claim 1, wherein said pole may comprise a plurality of telescoping segments.

4. The telerobot as in claim 1, wherein said pole may comprise a plurality of segments, and said plurality of segments can be disassembled and reassembled.

5. The telerobot as in claim 1, wherein said pole serves as a track on which said videoconference device can slide up and down.

6. The telerobot as in claim 5, wherein said pole is curved such that said videoconference device may face a user at various angles when sliding up and down said pole.

7. The telerobot as in claim 1, wherein a weighty component can be shifted frontward and backward inside said body by one motor, of said plurality of motors, which is independent of said motors driving said wheels, such that the center of gravity of said telerobot can be shifted frontward and backward with respect to said body.

8. The telerobot as in claim 1, wherein said pole is hinged on a top part of said body and a low end of said pole inside said body can be shifted frontward and backward with respect to said body by one motor, of said plurality of motors, which is independent of said motors driving said wheels.

9. The telerobot as in claim 1, wherein said pole is hollow such that a plurality of cables may run through said pole.

10. The telerobot as in claim 1, wherein a motor controls angles of said videoconference device relative to said pole.

11. The telerobot as in claim 1, wherein said videoconference device swaying backward due to inertia when said telerobot moving forward is compensated by automatically adjusting inclination of said videoconference device relative to said pole.

12. The telerobot as in claim 1, wherein text input can be performed by tracking user's fingertip on images captured via said videoconference device, wherein relative movement of said fingertip moves a cursor on a virtual keyboard displayed on said videoconference device.

13. The telerobot as in claim 12, wherein a key on said virtual keyboard, at the position of said cursor, is selected when said cursor remains stationary for a period of time.

14. The telerobot as in claim 12, wherein said virtual keyboard, optimized for gesture control text input, comprising: keys of a regular convex polygon shape, joined side by side, forming a big polygon, wherein the more frequently used keys are placed closer to the center of said big polygon.
